(19) United States
(12) Patent Application Publication
(10) Pub. No.: US 2011/0107397 A1
(43) Pub. Date: May 5, 2011

(54) System, Method and Computer Program Product for Securing Legal Documents

(76) Inventor: Meir Niv, West Hill, CA (US)

(21) Appl. No.: 12/610,263

(22) Filed: Oct. 30, 2009

(51) Int. Cl. G06F 21/24; H04L 9/32; G06F 15/16

(52) U.S. Cl. 726/3; 726/30; 709/204; 709/206

(57) ABSTRACT

A system, method and computer program product for securing legal documents includes connecting to a server for exchanging at least one document with a contracting party. Identities of contracting parties and ownership of the at least one document are authenticated by the server. The at least one document is exchanged with the contracting party for conducting a business transaction. The at least one document is communicated through the server and content of the at least one document is stored as read-only in a secured data bank along with at least a date and time of the exchange and locations and identities of contracting parties engaged in the business transaction.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to web servers. More particularly, the invention relates to a bonded web server that serves as a data bank on the Internet.

### BACKGROUND OF THE INVENTION

Wherever there are people, there is a need for secure legal documentation, whether it is a multi-national corporation, a large prestigious law firm, a small business, or the personal legal needs of an individual. In today's economy, contracts and legal agreements can be drawn by complete strangers around the globe. Large sum of money exchange hands, gigantic conglomerates form mergers, and enormous amounts of legal data is generated. Any mistake or disagreement can have disastrous consequences. It is therefore an objective of the present invention to provide means for generating and storing legal documents that can generally eliminate misunderstandings and resolve possible conflicts without having to resort to costly and unpleasant battles in courts of law.

At the present time, most contracts and legal documents are written on paper. Even if the preparation and supporting data is stored in a database on computers, the final contractual document is on paper with handwritten signatures and possibly the seal and signature of a Notary Public or witness to authenticate the document. All of this paper requires large amounts of physical storage where documents may be lost, misfiled, damaged, or destroyed. Furthermore, most communication is delivered today through cyberspace. Even if using traditional methods (i.e., telephones, fax machines, paper mail, etc.), the result is typically the same as if delivered by the Internet. The former modes of communication have become outdated and obsolete, and more and more communications and negotiations are done remotely. The same eye and voice contact obtained from in person meetings is currently available using online technology, as if the parties are present in the same room. It is therefore an objective of the present invention to provide means and methods for executing and safely storing contracts and legal documents without the use of paper that are available remotely over the Internet.

Email is a fast, convenient means of communication and is well accepted. Many people correspond today using email, and emails often replace paper mail. Among one of email's many functions, using email as a legal commitment by sending an email with the intention of making it a legal document can enable people to execute a legal document without the use of paper. As long as the sender and the recipient are honest and agree to the legality of the email there is no problem. However, when a dispute arises about the legality of the email, it is very difficult to accept the email as a legal document. The reason that email is not safe as a legal entity is that there is nothing more easily forged than an email. For example, without limitation, the email sender address is not guaranteed to be authentic and can be made up; the recipient of the email can change the content at will with no record of the changes; an email can be produced even if no one sends it, etc. It is therefore an objective of the present invention to provide a solution for generally eliminating email fraud and for authenticating the legality of email, without sacrificing any of the convenience of email.

In view of the foregoing, there is a need for improved techniques for providing means for creating, executing and storing legal documents without the use of paper over the Internet that generally eliminates fraud and authenticity issues and enables users to safely use email for these purposes.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an exemplary web bonded data bank (WBDB) system that provides a service whereby legal documents can be created, negotiated, executed, stored, and viewed without the use of paper, in accordance with an embodiment of the present invention;

FIG. 2 is a block diagram illustrating an exemplary solution for generally eliminating email fraud and for authenticating the legality of an email in a web bonded data bank (WBDB) system, without sacrificing any of the conveniences of email, in accordance with an embodiment of the present invention; and

FIG. 3 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and computer program product for securing legal documents is presented.

In one embodiment a system for securing legal documents is presented. The system includes means for connecting to a server to exchange at least one document with a contracting party, means for authenticating identities of contracting parties and ownership of the at least one document, means for exchanging the at least one document with the contracting party to conduct a business transaction, means for storing the at least one document as read-only in a secured data bank along with at least a date and time of the exchange and locations and identities of contracting parties engaged in the business transaction. Another embodiment further includes means for sending a physical document to the contracting party, wherein a copy of the physical document is stored as read-only in the secured data bank. Still another embodiment further includes means for translating a language of the at least one document and storing as read-only in the secured data bank. Yet another embodiment further includes means for establishing a telephonic communication with the contracting party and storing the telephonic communication as read-only in the secured data bank. Another embodiment further includes means for creating the at least one document as an email. Still another embodiment further includes means for accessing the at least one document for viewing, wherein the accessing is enabled by validating authorization.

In another embodiment a method for securing legal documents is presented. The method includes connecting to a server for exchanging at least one document with a contracting party, wherein identities of contracting parties and ownership of the at least one document are authenticated by the server. The at least one document is exchanged with the contracting party for conducting a business transaction. The at least one document is communicated through the server and content of the at least one document is stored as read-only in a secured data bank along with at least a date and time of the exchange and locations and identities of contracting parties engaged in the business transaction. Another embodiment further includes sending a physical document to a center managing the secured data bank for forwarding to the contracting party, wherein a copy of the physical document is produced, the copy is stored as read-only in the secured data bank and the physical document is forwarded to the contracting party. Still another embodiment further includes requesting a language translation of the at least one document. The language translation of the at least one document is communicated through the server to the contracting party and content of the language translation of the at least one document is stored as read-only in the secured data bank along with the at least one document. Yet another embodiment further includes establishing a telephonic communication with the contracting party for conducting the business transaction. Content of the telephonic communication is stored as read-only in the secured data bank along with at least a date, time and duration of the telephonic communication and identities of contracting parties engaged in the telephonic communication. Another embodiment further includes creating the at least one document as an email using a first email program in communication with the server. The contracting party uses a second email program in communication with the server for receiving the email from the first email program. Still another embodiment further includes accessing the at least one document for viewing. The accessing is enabled by validating authorization. In yet another embodiment the at least one document is encrypted and provided with an authentication code.

In another embodiment a computer program product for securing legal documents is presented. The computer program product includes computer program code for connecting to a server for exchanging at least one document with a contracting party, wherein identities of contracting parties and ownership of the at least one document are authenticated by the server. Computer program code exchanges the at least one document with the contracting party for conducting a business transaction, wherein the at least one document is communicated through the server and content of the at least one document is stored as read-only in a secured data bank along with at least a date and time of the exchange and locations and identities of contracting parties engaged in the business transaction. A computer-readable media stores the computer program code. Another embodiment further includes computer program code for copying a physical document and storing the copy as read-only in the secured data bank. Still another embodiment further includes computer program code for language translation of the at least one document, wherein the language translation of the at least one document is communicated through the server to the contracting party and content of the language translation of the at least one document is stored as read-only in the secured data bank along with the at least one document. Yet another embodiment further includes computer program code for storing content of a telephonic communication as read-only in the secured data bank along with at least a date, time and duration of the telephonic communication and identities of contracting parties engaged in the telephonic communication. Another embodiment further includes computer program code for creating the at least one document as an email using a first email program in communication with the server, wherein the contracting party uses a second email program in communication with the server for receiving the email from the first email program. Still another embodiment further includes computer program code for accessing the at least one document for viewing, wherein the accessing is enabled by validating authorization. In yet another embodiment the at least one document is encrypted and provided with an authentication code.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Preferred embodiments of the present invention provide a web bonded data bank (WBDB), which is a private membership website that serves as a highly secured data bank on the Internet, bypassing the conventional paper handling presently in practice. Data stored using preferred embodiments is generally secure against unauthorized intrusion. The WBDB website in preferred embodiments is highly secure and bonded. Access to the WBDB website in preferred embodiments is limited to registered users that are carefully screened, and all of the vital information pertaining to these registered users is kept on file.

In order to provide a WBDB website according to preferred embodiments the following requirements must be met. Users must be qualified, meaning the system must have all necessary data about the customer. By qualifying users, the system is able to protect against illegal entry and verify the legitimacy of users. To be qualified, users are required to sign a self-disclosure contract, testifying that all personal and financial information furnished to the system is true and correct. Preferred embodiments also require crucial data to be encrypted to guard against external and internal attack. In preferred embodiments the WBDB website and all of its personnel are bonded and all services are insured. Finally in preferred embodiments, if changes must be made to documents stored in the data bank, the original document is saved to the archives and is no longer active and the new document becomes the current legal document.

Preferred embodiments of the present invention provide a WBDB website that serves as a data bank for legal documents that is bonded, insured, secured, and protects the integrity of the data. These preferred embodiments were created because of a need to incorporate new technology to meet the changing legal needs of contemporary society while guarantying compliance with definitions and requirements of legal documents.

For the purposes of the present description, a legal document is defined as a document that states some contractual relationship or grants some right. The requirements for a document to be considered legal are as follows. The identity of the owner or institution must be known and this owner must have composed and executed the document of his own free will, meaning that the document was drawn in good faith. The time, date and place where the document was executed must also be known. All parties involved with the document must agree to its legality and obligations. Once executed, the contents of the original document cannot be altered. If a change is required, a new document is created and flagged, referencing back to the original document. An impartial third party must testify to the authenticity of the document. Finally, the document must have a legal obligation, and a judge can view the document in consideration of making a judgment.

There is an infinite number of types of legal documents, so there will be no attempt to list them all. However for the sake of clarity, the following non-limiting list is provided to name a few of the most obvious types of legal documents: notes representing a monetary obligation, agreements or promises between two or more parties, money (i.e., legal tender), contracts, committed emails, intellectual property, patents, government documents, corporate documents, stock and bond certificates, judgments, promotion certificates, formulas, engineering designs, certificates of ownership of physical objects, and personal legal data including, but not limited to, social security numbers, credit card account numbers, bank savings and checking account numbers, evidence of property ownership, trust deeds, business licenses, diplomas, marriage certificates, birth certificates, passports, prenuptial agreements, wills, living trusts, trust fund documents, etc.

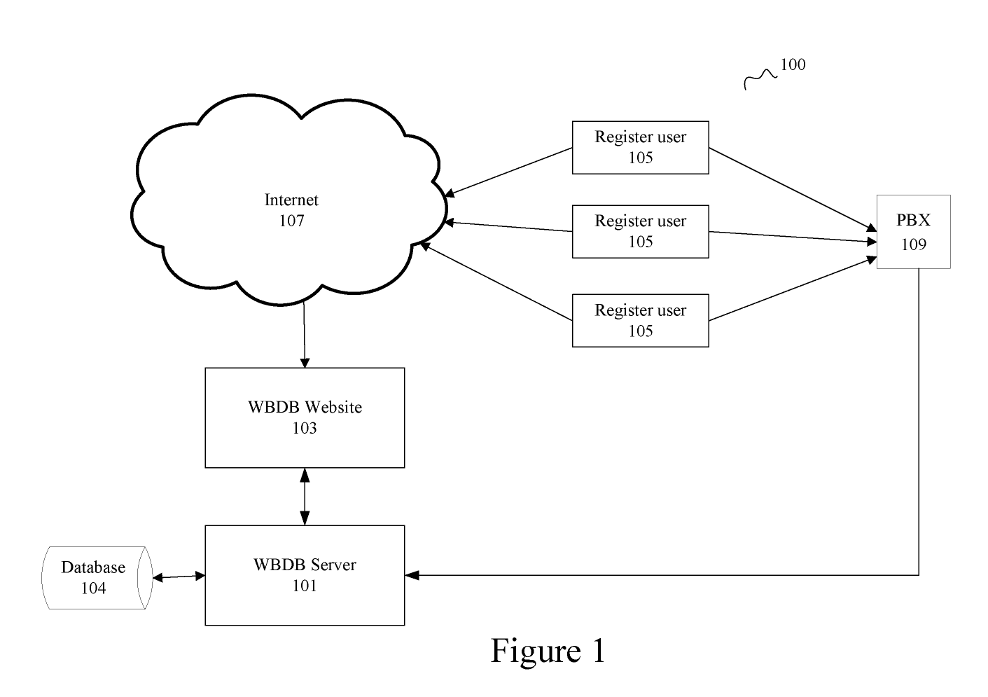

FIG. 1 is a block diagram illustrating an exemplary web bonded data bank (WBDB) system 100 that provides a service whereby legal documents can be created, negotiated, executed, stored, and viewed without the use of paper, in accordance with an embodiment of the present invention. The integrity of the legal document is protected because it generally cannot be lost, destroyed, changed or altered. The legal document can be easily accessed and specific data within the document can be easily found by registered users 105. There is no need for the use of cumbersome physical file storage where legal documents may be lost, misfiled, damaged or destroyed. Data is sent to a WBDB server 101 of a WBDB website 103 where this data is stored with the associated information (e.g., date, time, location, hardware id, etc.) in a database 104. The data is then forwarded to the recipient. WBDB server 101 may be a server on any type of platform for example, without limitation, a web server, a network server or any permanent memory on a device such as, but not limited to, hard disks, flash drives, CDs, etc. Furthermore, the data stored in database 104 may be any type of data including, but not limited to, data files, database records, graphic data, photos, music, audio or voice data, videos, etc.

In the present embodiment, WBDB website 103 provides a virtual private network where only registered users 105 have access. The indentifying information of registered users 105 is used for protection, and all registered users 105 must sign a pledge that the personal information they have provided is true and correct. This meets the requirement of a legal document of knowing the owner of the document. Registered users 105 can control who can view their data. This enables registered users 105 to allow other parties to view their data, for example, without limitation, a judge who needs to consider the document in order to make a judgment. Documents generally cannot be lost or destroyed in WBDB system 100. Once a document is executed in the present embodiment, it cannot be changed or altered, which is another requirement of a legal document. If changes, additions or deletions are required, a new document is created and executed, and the original document is stored, as is, in an archive. This enables registered users 105 to reference back to the original document. In some embodiments a document compare function is available. This allows registered users to quickly view differences between the current active document and any archived version. Together with the document, all supporting communications leading up to creation and execution of the document are stored in database 104 to meet the requirement that the time, date and place where the document was executed must be known. WBDB system 100 is the authenticating third party, impersonal and impartial, which meets yet another requirement for legal documents. The integrity of a legal document executed and stored in the present embodiment is protected because it generally cannot be lost, destroyed, changed or altered and the identities of the contracting parties are guaranteed.

Most communication today is delivered through cyberspace, and the former modes of communication are becoming outdated and obsolete. More and more communications and negotiations are done remotely. In the present embodiment, WBDB website 103 enables communication to be performed remotely. Some of the benefits of this are described in the following. All records of communication and negotiation are automatically saved. There is no need to travel to negotiate or execute an agreement or legal contract. WBDB system 100 makes it easy to organize and initiate collaboration between groups of people. All documents are stored online and are easily accessed; eliminating the problems of storage and security, and specific data within the document can be searched and found. In some embodiments, stored documents containing audio communications can be searched for words or phrases. In a non-limiting example, a registered user can specify a specific word or phrase to search for in one or more audio files. A speech to text converter is then used locate the portion or portions of the audio containing the word or phrase. The registered user would then be able to listen to the portion or portions of audio. In another embodiment, the registered user can be supplied with a transcription of the audio communication. In some other embodiments, documents containing video of contracting parties can be searched for individuals. In a non-limiting example, a registered user could choose an image of a person to search for. Image recognition software, such as, but not limited to, facial recognition, can search the video files for that person. This requires that the contracting parties provide photos and attest to their authenticity. In yet another embodiment, the registered user could upload a photo of a person he wishes to search for. In this case, the photo would not be saved since the authenticity has not been attested to and would only be used for the search. In another embodiment, documents containing graphical images, such as, but not limited to, mechanical parts, schematic diagrams, designs, etc., can be searched using pattern recognition. In a non-limiting example, the registered user would supply an image of the object to be searched for. Pattern recognition software would then scan the graphic files for similar images. In all embodiments, the ease of access and searchability of the documents generally eliminates the need for time consuming copying and paper handling and the use of cumbersome physical file storage. With a global society, many languages are spoken. Communications, negotiations and documents in the present embodiment are automatically translated into the languages spoken by the parties involved, generally eliminating the expense of hiring translators. The translation of the documents is semi automatically, at the request of one or more contracting parties, when the document is received by the server. Both the original language and the translated language of the documents are stored. In the present embodiment, by way of example, and not limitation, the translate document is reverse translated to the original language so that the author can check the double translated document to see if the content and meaning of the data did not get lost in translation. Translation is preferably performed by the server automatically (e.g., Google developed this function), there will be some command in the email requesting to translate and specify the language. The documents can be made easily accessible to parties with legal permission to view them including, but not limited to, parties negotiating and creating the document, parties that may have an interest in the contract or document, courts of law, parties authorized to view the document such as, but not limited to, next of kin, beneficiaries, etc. In some embodiments, extensive access logs are maintained to record data such as, but not limited to, times and duration of access by registered users, activities of registered users, such as, but not limited to, searches and documents retrieved, etc.

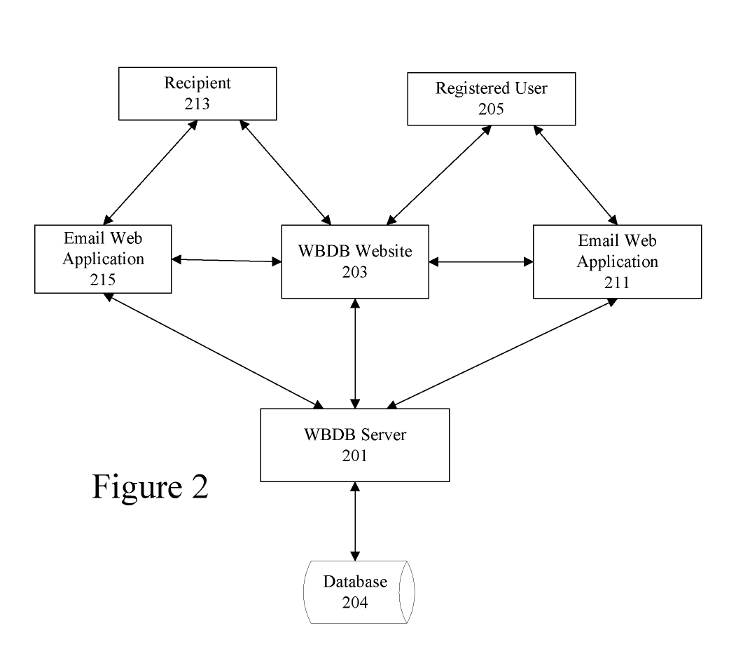

In the present embodiment, WBDB website 103 uses the Internet 107 as the medium whereby all documents are created, negotiated, agreed upon, executed, saved, stored and reviewed to enable registered users 105 to communicate remotely, creating an environment that will fulfill all the requirements described in the foregoing for a document to be considered legal. All data can be written only once, and once a document is executed, it cannot be changed or altered. If changes, additions or deletions are required, a new document is created and executed, and the original document is stored, as is, in an archive in database 104. The present embodiment provides safe storage where documents generally cannot be lost or destroyed and where the longevity of documents is extended. All supporting communications leading up to creation and execution of the document are stored in WBDB system 100. Ambiguity and misunderstandings are generally eliminated by choosing to record all negotiations. WBDB system 100 is the authenticating third party, impersonal and impartial. If the document is contested or its legality challenged, the communications and negotiations prior to execution of the document can be produced. There is no need for legal discovery or investigation into the legality of the document. All proof of the integrity and legality of the document is stored in WBDB system 100. Furthermore, WBDB system 100 assists lawyers in the process of discovery, as discovery data is saved in database 104 where the data can be searched and found easily. Documents can also be accessed instantaneously. The parties involved in the creation and execution of the document understand that proof of its integrity and authenticity is stored in WBDB system 100. These parties generally cannot claim that the document does not express their true wishes, that they did not understand, or that they were coerced or misled. It would be unlikely that any party would initiate litigation to challenge the legality of documents created and executed in this manner. Security provided when using an email function using program-to-program communication protects against outside interference, as described by way of example in accordance with FIG. 2. Limited access to WBDB system 100 makes it difficult for hackers and criminals to penetrate WBDB system 100 and generally eliminates the possibility of forgery, alteration or destruction of documents.

The following attributes of the present embodiment generally ensure the safety, security and legality of WBDB system 100. WBDB system 100 comprises a built in mechanism to generally ensure that the data cannot be violated by internal or external forces. By having to program communication generally assures assuring that the software guarantees the authentication of the user. Registered users access the system only after an elaborate means for identification and means for authenticating procedure that includes, but not limited to, hardware identification and biometric identification. The user will have a very elaborate identification procedure which will include hardware ID (like personal cell phone) and bio id (like finger print) or other bio identification. Only users registered will have access. Data obtained the identification procedure is compared to authenticated data. Documents are encrypted and once stored in the data bank cannot be deleted or altered in any way. All data that is transmitted to a contracting party carries an electronic code such as, but not limited to, a (cyclic redundancy code (CRC). When the data is received, a calculated electronic code is compared to the transmitted code. If there is no exact match the data is rejected). Basically some algorithm of calculation of the entire data is done and the result is a code. At the receiving end the code is recalculated and if the two codes match, the data is considered authentic. If it does not match the data has to be resent until there is a match. The operators of WBDB server 101 are carefully screened and bonded and have limited access to information in WBDB system 100. Operators are unable to alter the data. All customers are registered users 105 of WBDB website 103. WBDB system 100 maintains on record enough personal information and proof of identity of registered users 105 to protect registered users 105 from unauthorized persons breaking into WBDB system 100 and gaining access to secure documents. WBDB system 100 is set up so that all communication goes through WBDB server 101 and is recorded. This information is stored in database 104 and cannot be deleted or changed.

In the past negotiations were done in person, or by telephone or mail. Today the methods of communication have become much more sophisticated. The present embodiment is designed to record all available forms of communication using correspondence (i.e., voice and data) sent through computing devices such as, but not limited to, desktop computers, laptops, notebooks, mobile phones, etc., and methods of computer network correspondence including, but not limited to, email, file transfer protocol (FTP), chat, IM, text messaging, mobile to mobile, mobile to PC, audio, computer to computer, computer to phone, conference call, local, remote, Skype type voice video, sharing and collaboration, etc.

If registered users 105 require a secure communication, their communication is first be forwarded to WBDB server 101. The content of the communication is saved in data bank 104 along with information such as, but not limited to, date, time, computer source, IP address, etc. Then WBDB server 101 forwards the communication to the recipient who is also a registered user 105. The copy of the communication stored on WBDB server 101 cannot be deleted or altered. WBDB server 101 has records of the date and time the communication was received, when it was opened and read and if it was deleted by the recipient. Because the communication goes through WBDB server 101, WBDB system 100 can trace the communication from beginning to end.

Non-computing communication methods including, but not limited to, telephone, fax machines, and traditional mail service may also be recorded by the present embodiment. However, alternate embodiments may be implemented that do not record non-computing communication methods. In the present embodiment, telephone messages go to a telephone private branch exchange (PBX) 109 which forwards the connection to the recipient. All conversations are recorded and WBDB server 101 keeps records of the date, time, telephone number and duration of the call. Faxed messages are copied, saved and forwarded to the recipient and the date and time received is recorded in WBDB server 101 along with the location and phone numbers of the sender and the recipient. Mail is sent to a center for managing WBDB system 100, the envelope is opened and the content is scanned and saved in WBDB server 101 with corresponding data and then re-mailed to the recipient. WBDB server 101 may send the mail message in its original form or as an email or a fax to the recipient. WBDB server 101 may also send a fax in its original form or as an email or letter. Once data is stored in WBDB system 100, the data has the same attributes as if it were entered by a computing device. The present embodiment enables users to use familiar methods of conducting everyday business by computers and non-computing devices without any learning curve.

FIG. 2 is a block diagram illustrating an exemplary solution for generally eliminating email fraud and for authenticating the legality of an email in a web bonded data bank (WBDB) system, without sacrificing any of the conveniences of email, in accordance with an embodiment of the present invention. In the present embodiment, a registered user 205 sends an email from a web application 211 on a WBDB website 203 that has direct program-to-program communication with a WBDB web server 201 YES rather than from an open public domain popular email. The look and feel of the user interface is the same as a regular email interface with some additional functions such as, but not limited to, email. Functions are: Email as a binding contract, preliminary. Preliminary discussion and negotiation, email. Email as a draft, email. Email to be translated, option. Option send back reverse translation, email. Email to be stored only, email. Email revision of some project, email. Email in collaboration, email. Email as signature to a contract, print. Print the email contract and mail to users, email. Email to send to a group.

Only registered users 205 can participate in email correspondence in the WBDB system. The identity of registered users 205 is well known by the system as strict and secure login procedures are in place to authenticate registered users 205 such as, but not limited to, hardware and bio identification (every computer or PDA has an ID). Email sent through the system is saved on a server database 204. YESThe email data can never be deleted, changed or appended. In order to change email data, a new email should be send with a back reference to the existing email. All supporting information about the email is also saved on server database 204 including, but not limited to, date and time, IP address, hardware ID, etc. WBDB server 201 forwards the email to a recipient 213 who is also a registered user of the system. At WBDB server 201 a log records any time the email is viewed and by whom in database 204.

Recipient 213 also uses a web application 215 that communicates directly with WBDB web server 201 to view the email. All the events concerning the email are sent to WBDB server 201 to be stored with the email data such as, but not limited to, when the list was opened, when the email was opened to be read, what was done with the email (e.g., deleted, saved or left in the list), information about the IP, date, time, and hardware ID, etc. Software in the WBDB system assists in organizing the legal email documents for example, without limitation, by users, category, subject, session, level of legality (e.g., contract, parliamentary, navigation, exploratory, etc.), usage, judgment, date, etc. In FIG. 2, communication lines between registered user 205 and WBDB website 203, and between recipient 213 and WBDB website 203 indicate not only means for electronic communication but also means for exchanging physical documents such as, but not limited to, paper mail, faxes, printed documents, etc.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

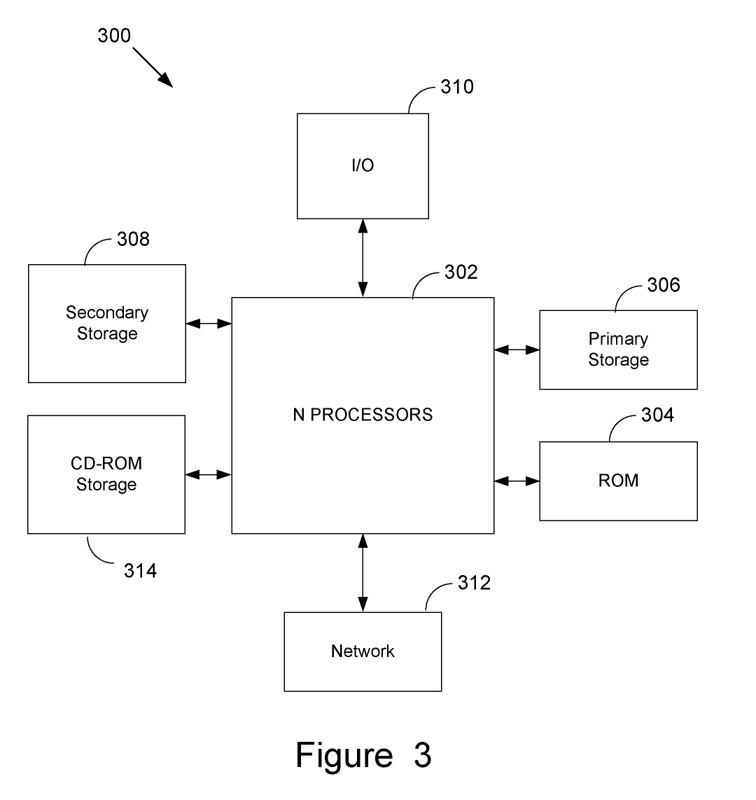

FIG. 3 illustrates a typical computer system that, when appropriately configured or designed, can serve as a computer system in which the invention may be embodied. The computer system 300 includes any number of processors 302 (also referred to as central processing units, or CPUs) that are coupled to storage devices including primary storage 306 (typically a random access memory, or RAM), primary storage 304 (typically a read only memory, or ROM). CPU 302 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 304 acts to transfer data and instructions uni-directionally to the CPU and primary storage 306 is used typically to transfer data and instructions in a bi-directional manner. Both of these primary storage devices may include any suitable computer-readable media such as those described above. A mass storage device 308 may also be coupled bi-directionally to CPU 302 and provides additional data storage capacity and may include any of the computer-readable media described above. Mass storage device 308 may be used to store programs, data and the like and is typically a secondary storage medium such as a hard disk. It will be appreciated that the information retained within the mass storage device 308, may, in appropriate cases, be incorporated in standard fashion as part of primary storage 306 as virtual memory. A specific mass storage device such as a CD-ROM 314 may also pass data uni-directionally to the CPU.

CPU 302 may also be coupled to an interface 310 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 302 optionally may be coupled to an external device such as a database or a computer or telecommunications or internet network using an external connection as shown generally at 312, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, regarding the operation of the website and data bank, to satisfy any jurisdictional requirements, if the parties involved in the contract are from different countries they would agree before negotiations begin, which may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing means for creating, executing and storing legal documents without the use of paper according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of network used. The systems described in the foregoing were directed to Internet based implementations; however, similar techniques are to implement systems on networks other than the Internet, for example, without limitation, local area networks (LANs), private networks of entities such as, but not limited to, corporations, organizations, law firms, etc. Non-Internet based implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A system for securing legal documents, the system comprising:
means for connecting to a server to exchange at least one document with a contracting party;
means for authenticating identities of contracting parties and ownership of said at least one document;
means for exchanging said at least one document with said contracting party to conduct a business transaction; and
means for storing said at least one document as read-only in a secured data bank along with at least a date and time of said exchange and locations and identities of contracting parties engaged in said business transaction.

2. The system as recited in claim 1, further comprising means for sending a physical document to said contracting party, wherein a copy of said physical document is stored as read-only in said secured data bank.

3. The system as recited in claim 1, further comprising means for translating a language of said at least one document and storing as read-only in said secured data bank.

4. The system as recited in claim 1, further comprising means for establishing a telephonic communication with said contracting party and storing said telephonic communication as read-only in said secured data bank.

5. The system as recited in claim 1, further comprising means for creating said at least one document as an email.

6. The system as recited in claim 1, further comprising means for accessing said at least one document for viewing, wherein said accessing is enabled by validating authorization.

7. A method for securing legal documents, the method comprising:
connecting to a server for exchanging at least one document with a contracting party, wherein identities of contracting parties and ownership of said at least one document are authenticated by said server; and
exchanging said at least one document with said contracting party for conducting a business transaction, wherein said at least one document is communicated through said server and content of said at least one document is stored as read-only in a secured data bank along with at least a date and time of said exchange and locations and identities of contracting parties engaged in said business transaction.

8. The method as recited in claim 7, further comprising sending a physical document to a center managing said secured data bank for forwarding to said contracting party, wherein a copy of said physical document is produced, said copy is stored as read-only in said secured data bank and said physical document is forwarded to said contracting party.

9. The method as recited in claim 7, further comprising requesting a language translation of said at least one document, wherein said language translation of said at least one document is communicated through said server to said contracting party and content of said language translation of said at least one document is stored as read-only in said secured data bank along with said at least one document.

10. The method as recited in claim 7, further comprising establishing a telephonic communication with said contracting party for conducting said business transaction, wherein content of said telephonic communication is stored as read-only in said secured data bank along with at least a date, time and duration of said telephonic communication and identities of contracting parties engaged in said telephonic communication.

11. The method as recited in claim 7, further comprising creating said at least one document as an email using a first email program in communication with said server, wherein said contracting party uses a second email program in communication with said server for receiving said email from said first email program.

12. The method as recited in claim 7, further comprising accessing said at least one document for viewing, wherein said accessing is enabled by validating authorization.

13. The method as recited in claim 7, wherein said at least one document is encrypted and provided with an authentication code.

14. A computer program product for securing legal documents, the computer program product comprising:
computer program code for connecting to a server for exchanging at least one document with a contracting party, wherein identities of contracting parties and ownership of said at least one document are authenticated by said server;
computer program code for exchanging said at least one document with said contracting party for conducting a business transaction, wherein said at least one document is communicated through said server and content of said at least one document is stored as read-only in a secured data bank along with at least a date and time of said exchange and locations and identities of contracting parties engaged in said business transaction; and
a computer-readable media for storing said computer program code.

15. The computer program product as recited in claim 14, further comprising computer program code for copying a physical document and storing said copy as read-only in said secured data bank.

16. The computer program product as recited in claim 14, further comprising computer program code for language translation of said at least one document, wherein said language translation of said at least one document is communicated through said server to said contracting party and content of said language translation of said at least one document is stored as read-only in said secured data bank along with said at least one document.

17. The computer program product as recited in claim 14, further comprising computer program code for storing content of a telephonic communication as read-only in said secured data bank along with at least a date, time and duration of said telephonic communication and identities of contracting parties engaged in said telephonic communication.

18. The computer program product as recited in claim 14, further comprising computer program code for creating said at least one document as an email using a first email program in communication with said server, wherein said contracting party uses a second email program in communication with said server for receiving said email from said first email program.

19. The computer program product as recited in claim 14, further comprising computer program code for accessing said at least one document for viewing, wherein said accessing is enabled by validating authorization.

20. The computer program product as recited in claim 14, wherein said at least one document is encrypted and provided with an authentication code.
